(19) United States
(12) Patent Application Publication
(10) Pub. No.: US 2006/0197828 A1
(43) Pub. Date: Sep. 7, 2006

(54) Method and system for delivering dual layer hdtv signals through broadcasting and streaming

(75) Inventors: Yonggin Zeng, Shanghai (CN); Fons Bruis, Eindhoven (NL); Ningjiang Chen, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: koninklijke phillips n.v.

(21) Appl. No.: 10/548,259

(22) PCT Filed: Dec. 2, 2003
(86) PCT No.: PCT/IB03/05697

§ 371 Date: Sep. 6, 2005

(30) Foreign Application Priority Data
Dec. 20, 2002 (CN) 02157462.6

(51) Int. Cl. H04N 11/04

(52) U.S. Cl. 348/14.13; 375/240.01; 375/240

(57) ABSTRACT

The present invention provides a method and system for delivering SDTV/HDTV services that achieves significant bandwidth savings, while keeping the existing SDTV transmission unchanged. In accordance with one embodiment of the invention, a system is provided for delivering HDTV signals. In this system, an HD enhancement layer containing an HD enhancement data stream is obtained\. The HD enhancement layer is delivered to a server to enable a subscriber to access the server, via a set top terminal, to receive the HD enhancement layer over a network system. In another embodiment of the invention, a base layer containing a SD data stream is also delivered to the set top terminal to allow the terminal to integrate the HD enhancement layer and the base layer into a HDTV output.

### BACKGROUND OF THE INVENTION

The invention relates generally to digital broadcasting technologies, and more particularly to SDTV (standard definition TV)/HDTV (high definition TV) compatible broadcasting technologies.

Conventionally, TV service providers simultaneously broadcast SDTV (e.g., 720×576i, 50 Hz) and HDTV (e.g., 1920×1080i, 50 Hz) signals, both containing the same programs, via satellite, cable, or terrestrial transmission. As the laws have been passed in a number of countries, requiring complete migration from the SDTV to HDTV services in a few years, TV service providers will have to add more HDTV channels while maintaining some SDTV channels for backward compatibility so as to provide TV viewers with a smooth transition. In order to add more SDTV and HDTV channels, it is necessary for TV service providers to more efficiently use the available bandwidths.

In existing MPEG2 HDTV/SDTV compatible broadcasting techniques, a SD transport stream (e.g. 4-6 Mbps) and a HD transport stream (e.g. 18 Mbps), both containing the same program, are modulated and simultaneously broadcasted on one standard analog channel (6 MHz, 24 Mbps). A major drawback is that it takes the upper limit of the bandwidth within one analog channel leaving few bandwidth for the modulation overhead. The reason is that with the 4 Mbps and 18 Mbps being allocated to the SD and HD transport streams, respectively, it can provide only the lower limit of the quality for the SDTV and HDTV signals. Thus, the conventional way of transmitting both HDTV and SDTV signals within one analog channel leads to either a higher threshold for receiving the HDTV and SDTV signals or a decline in the SDTV signal quality. Further, it requires two sets of encoders for encoding the HDTV and SDTV signals and also wastes the bandwidth by delivering duplicate SD portions of the contents.

A solution has been proposed to address the above drawbacks, while attempting to maintain backward compatibility with the existing SDTV broadcasting. The proposed solution utilizes a dual layer HDTV compression technology to deliver the HDTV dual layer streams through broadcasting. However, because the compression technology fails to produce significant bandwidth savings and requires substantial changes in the existing SDTV transmission systems, TV service providers are hesitant to use this solution. They are very reluctant to invest in the related transmission systems without being able to realize significant benefits.

Therefore, there is a need to provide an improved method and system for delivering SDTV/HDTV services that can overcome the above drawbacks and achieve significant savings in the traditional broadcasting bandwidth, while keeping the existing SDTV transmission unchanged.

### SUMMARY OF THE INVENTION

The present invention provides a method and system for delivering SDTV/HDTV services that overcomes the drawbacks associated with the existing broadcasting techniques and achieves significant bandwidth savings, while keeping the existing SDTV transmission unchanged.

In accordance with one embodiment of the invention, a system is provided for delivering HDTV signals. The system comprises means for obaining an HD enhancement layer containing an HD enhancement data stream, and means for delivering the HD enhancement layer to a server to enable a viewer to access the server, via a set top terminal, to receive the HD enhancement layer over a network system.

In accordance with another embodiment of the invention, the system further comprises means for delivering a base layer containing a SD data stream to the set top terminal to allow the terminal to integrate the HD enhancement layer and the base layer into a HDTV output.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 shows an overview of the invention in which dual layer SDTV/HDTV data streams are provided to TV viewers;

FIG. 2 is a functional block diagram of a HDTV STB in accordance with one embodiment of the invention; and

FIG. 3 is a functional diagram of a dual layer signal generation circuit which may be used to generate the dual layer signals.

Throughout the drawings, the same reference numerals indicate similar or corresponding features or functions.

### DETAILED DESCRIPTION OF THE PREFERRED EMBODIMENTS

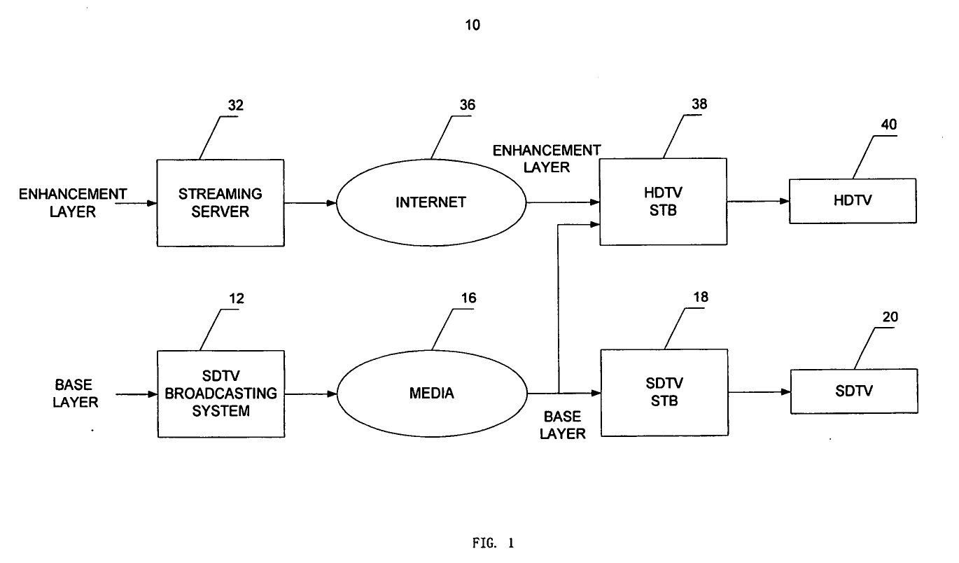

FIG. 1 shows an overview of the invention in which dual layer SDTV/HDTV data streams are provided to TV viewers. The dual layer includes a SD base layer containing a SD data stream and an HD enhancement layer containing an HD enhancement data stream. The base layer is directly and independently broadcast by a SDTV broadcasting system 12 and is transmitted via traditional media 16, e.g., terrestrial, cable, satellite, etc. A SDTV STB (set top box) 18 receives and decodes the SD data stream and sends the decoded signals to a SDTV 20.

The HD enhancement data stream, on the other hand, is provided to a streaming server 32 for delivering to TV viewers over the Internet 36, through, e.g., an advanced broadband IP network that implements, for instance, DVB-IPI (Digital Video Broadcasting Internet Protocol Infrastructure) protocols. The advanced IP network can deliver audio/video (A/V) data over the Internet while guaranteeing QoS (Quality of Service). This saves the traditional broadcasting bandwidth, while maintaining backward compatibility with the conventional SDTV broadcasting.

The data streams from the two layers are received by a HDTV STB 38. HDTV STB 38 decodes the received signals, integrates them into a HDTV output and then sends the HDTV output to a HDTV 40.

In this way, TV service providers could keep the SDTV broadcasting service unchanged for SDTV subscribers, while providing the HDTV service through the broadcasting and network streaming paths for another group of subscribers who are willing to pay higher fees for a better A/V quality. Meanwhile, there will be no meaningful output generated if only the enhancement layer is obtained via the Internet.

The two layers of the signals can be protected in different ways that lead to a higher security for the contents. For example, the base layer can be protected in the same manner as that used in the existing SDTV broadcasting. As to the enhancement layer, apart from using user identification for viewing, copying protection can be achieved by using technologies available for content streaming over an IP network.

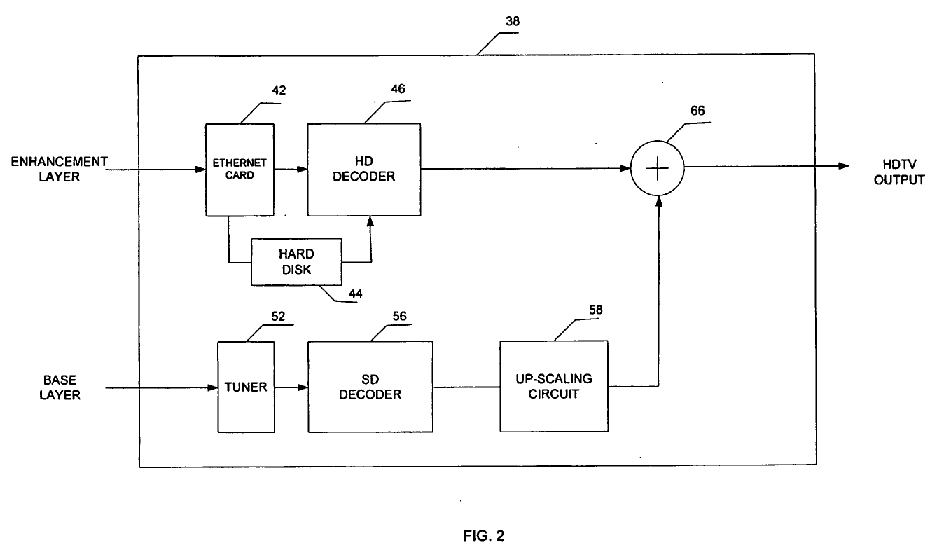

FIG. 2 is a functional block diagram of HDTV STB 38 in accordance with an embodiment of the invention. HDTV STB 38 includes an Ethernet card 42, a hard disk 44, a HD decoder 46, a tuner 52, a SD decoder 56, an up-scaling circuit 58, and an adder 66. HD decoder 46 receives the enhancement layer via Ethernet card 46 and decodes the data stream in the enhancement layer. This can be done by steaming the enhancement layer to HDTV STB 38 while a TV viewer is viewing the program, if the bandwidth of the IP network is sufficient. Otherwise, the enhancement layer contents can be pre-downloaded and stored on hard disk 44 for subsequent viewing by the TV viewer. The downloaded contents can be erased by the service provider afterwards.

SD decoder 56 receives the base layer via tuner 52 and decodes the data stream in the base layer. The output of SD decoder 56 is provided to up-scaling circuit 58 and is upgraded by circuit 58 to HD format signals. The outputs from HD decoder 46 and up-scaling circuit 58 are then integrated by adder 66 to generate a HDTV output for delivering to HDTV 40.

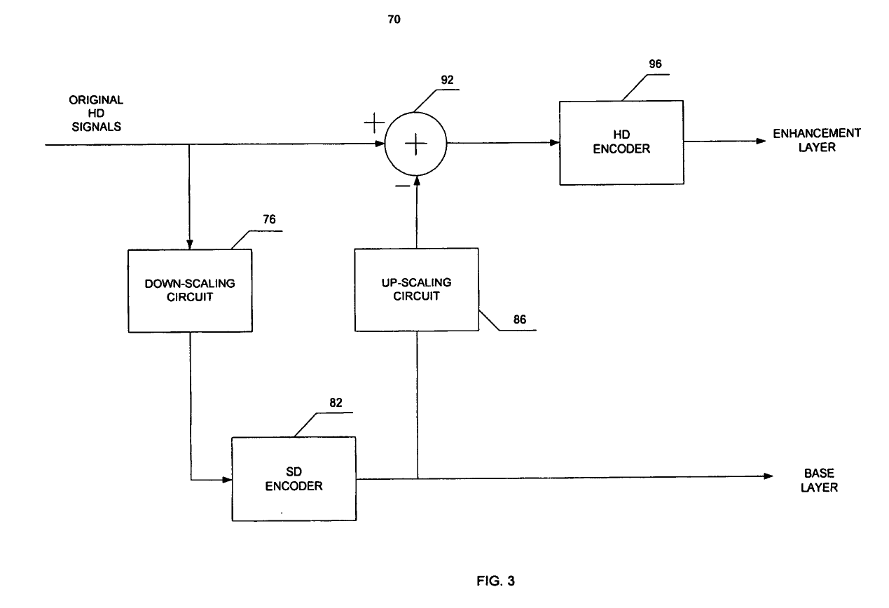

FIG. 3 is a functional block diagram of a dual layer signal generation circuit 70, which may be used to generate the base and enhancement layers. Circuit 70 includes a down-scaling circuit 76, a SD encoder 82, an up-scaling circuit 86, an adder 92 and a HD encoder 96. In circuit 70, the original HD signals are downgraded by down-scaling circuit 76 to SD format signals which are then encoded by SD encoder 82 to generate the base layer for broadcasting to the SDTV subscribers. The encoded SD signals are also upgraded by up-scaling circuit 96 to HD format signals. The upgraded signals and the HD signals are integrated by adder 92, and the integrated signals are encoded by encoder 96 to generate the enhancement layer.

In FIG. 3, the MPEG2 compression technology may be used in SD encoder 82 and HD encoder 96, so that conventional SD and HD encoders may be utilized. Alternatively, the MPEG2 compression technology may be used only in SD encoder 82, while the ITU H.264 compression technology may be used in HD encoder 96 to achieve much higher compression ratio. Additionally, if compatibility with the existing international standards is not essential, the ITU H.264 compression technologies or other compression technologies may be used in both the SD and HD encoders to generate the dual layer signals with even higher coding efficiency.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A system for delivering high-definition (HD) TV signals, comprising:
means for obtaining an HD enhancement layer containing an HD enhancement data stream; and
means for delivering the HD enhancement layer to a server to enable a viewer to access the server, via a set top terminal, to receive the HD enhancement layer over a network system.

2. The system of claim 1, further comprising means for delivering a base layer containing a standard definition (SD) data stream to the set top terminal to allow the terminal to integrate the HD enhancement layer and the base layer into a HDTV output.

3. The system of claim 2, wherein the obtaining means includes:
means for generating the base layer;
an upscaling circuit that is configured to upscale the base layer to generate HD format signals;
an adder, coupled to the upscaling circuit, that is configured to subtract the HD format signals from original HD signals to generate enhanced signals; and
a HD encoder, coupled to the adder, that is configured to encode the enhanced signals to generate the HD enhancement layer.

4. The system of claim 3, wherein the means for generating the base layer includes:
a downscaling circuit that is configured to downscale HD signals to generate SD format signals; and
a SD encoder, coupled to the downscaling circuit, that is configured to encode the SD format signals to generate the base layer.

5. The system of claim 4, wherein the HD encoder encodes the enhanced signals using ITU H.264 compression technology.

6. The system of claim 5, wherein the SD encoder encodes the SD format signals using MPEG2 compression technology.

7. The system of claim 5, wherein the SD encoder encodes the SD format signals using ITU H.264 compression technology.

8. A set top terminal, comprising:
means for decoding a high-definition (HD) enhancement layer containing an HD enhanced data stream;
means for decoding a base layer containing a standard-definition (SD) data stream;
an upscaling circuit, coupled to the means for decoding a base layer, that is configured to upscale the decoded base layer to HD format signals; and
means for integrating the decoded HD enhancement layer and the HD format signals into a HDTV output.

9. The terminal of claim 8, wherein the means for decoding an HD enhancement layer includes an HD decoder that is configured to decode the HD enhancement layer.

10. The terminal of claim 9, wherein the means for decoding a base layer includes:
a tuner for tuning the base layer received; and
a SD decoder, coupled to the tuner, that is configured to decode the base layer.

11. The terminal of claim 10, wherein the integrating means includes an adder, coupled to the HD encoder and the upscaling circuit, that is configured to combine the decoded HD enhancement layer and HD format signals into the HDTV output.

12. The terminal of claim 8, further comprising means for storing the HD enhancement layer.

13. The terminal of claim 12, wherein the storing means includes a hard disk.

14. A method for delivering high-definition (HD) TV signals, comprising the steps of:
obtaining an HD enhancement layer containing an HD enhancement data stream; and
delivering the HD enhancement layer to a server to enable a subscriber to access the server, via a set top terminal, to receive the HD enhancement layer over a network system.

15. The method of claim 14, further comprising a step of delivering a base layer containing a standard definition (SD) data stream to the set top terminal to allow the terminal to integrate the HD enhancement layer and the base layer into a HDTV output.

16. The method of claim 15, wherein the obtaining step includes:
generating the base layer;
upscaling the base layer to generate HD format signals;
subtracting the HD format signals from original HD signals to generate enhanced signals; and
encoding the enhanced signals to generate the HD enhancement layer.

17. The method of claim 16, wherein the step of generating the base layer includes:
downscaling HD signals to generate SD format signals; and
encoding the SD format signals to generate the base layer.

18. The method of claim 17, wherein the enhanced signals are encoded using ITU H.264 compression technology.

19. The method of claim 18, wherein the SD format signals are encoded using MPEG2 compression technology.

20. The method of claim 18, wherein the SD format signals are encoded using ITU H.264 compression technology.

21. The method of claim 15, wherein the base layer is delivered via broadcasting.

22. A method for providing a high-definition (HD) TV output, comprising the steps of:
decoding a high-definition (HD) enhancement layer containing an HD enhanced data stream;
decoding a base layer containing a standard-definition (SD) data stream;
upscaling the decoded base layer to HD format signals; and
integrating the decoded HD enhancement layer and the HD format signals into an HDTV output.

23. The method of claim 22, wherein the step of decoding a base layer includes:
tuning the base layer received; and
decoding the base layer.

24. The method of claim 22, further comprising a step of storing the HD enhancement layer.

25. The method of claim 24, further comprising means for erasing the stored HD enhancement layer after the enhancement layer is accessed by a viewer.
